(19) United States
(12) Patent Application Publication
(10) Pub. No.: US 2015/0187098 A1
(43) Pub. Date: Jul. 2, 2015

(54) METHOD AND APPARATUS FOR UNOBTRUSIVELY CHANGING IMAGERY SUPPLEMENTING A MAP DISPLAY

(71) Applicants: Andrew Ofstad, San Francisco, CA (US); Willem Van Lancker, New York, NY (US); Matthew R. Simpson, San Francisco, CA (US); Bernhard Seefeld, San Francisco, CA (US); Ryan Douglas Kuykendall, Seattle, WA (US)

(72) Inventors: Andrew Ofstad, San Francisco, CA (US); Willem Van Lancker, New York, NY (US); Matthew R. Simpson, San Francisco, CA (US); Bernhard Seefeld, San Francisco, CA (US); Ryan Douglas Kuykendall, Seattle, WA (US)

(73) Assignee: GOOGLE INC., Mountian View, CA (US)

(21) Appl. No.: 13/617,197

(22) Filed: Sep. 14, 2012

(51) Int. Cl. G06T 11/20; G06T 11/60

(52) U.S. Cl. CPC G06T 11/20; G06T 11/60

(57) ABSTRACT

In a computing device, images being displayed in connection with a digital map are unobtrusively updated. To this end, a digital map of a first geographic area and first images related to the first geographic area are displayed. A selection of a second geographic area is received. In response to the selection of the second geographic area, a digital map of the second geographic area and second images related to the second geographic area are displayed. One of the first images is temporarily, for a perceivable amount of time, displayed with the digital map of the second geographic area, where the displayed image is unrelated to the second geographic area.

### FIELD OF DISCLOSURE

This disclosure relates to user interfaces and, more specifically, to displaying map imagery on a display screen.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Maps are visual representations of information pertaining to the geographical location of natural and man-made structures. A traditional map, such as a road map, includes roads, railroads, hills, rivers, lakes, and towns within a prescribed geographic region. Maps were customarily displayed on a plane, such as paper and the like, and are now also commonly displayed via map applications on computing devices, such as computers, tablets, and mobile phones.

Maps displayed on computing devices are able to provide information not available from traditional paper maps. In particular, computing devices may provide the user with a photographic image of an object located within the boundary of the map that may be displayed on the screen. For example, a small visual indicator such as a thumbnail image may be displayed along with the map. The thumbnail image may denote that a photograph associated with a particular object physically located within the geographical area represented by the map is available for viewing, for example.

Although providing additional map-related information to the user (e.g., thumbnail images) can improve the map viewing experience, the manner in which the additional information is provided may interfere or distract the user's attention from the map. Thus, a need remains for providing map-related information to the viewer in a less obtrusive manner during the map viewing session.

### SUMMARY

An example embodiment of the techniques of the present disclosure is a method in a computing device for unobtrusively updating images being displayed in connection with a digital map. The method includes displaying a digital map of a first geographic area and first images related to the first geographic area. The method further includes receiving a selection of a second geographic area and, in response to the selection of the second geographic area, displaying a digital map of the second geographic area and second images related to the second geographic area. Displaying the digital map of the second geographic area and the second images includes temporarily, for a perceivable amount of time, displaying one of the first images with the digital map of the second geographic area, where the displayed one the first images is unrelated to the second geographic area.

In another example embodiment, a computer-readable memory has stored thereon a plurality of instructions for transitioning between images supplementing a map display. The plurality of instructions includes instructions that, when executed by one or more processors, cause the one or more processors to display a digital map including a visual representation of a first geographic area viewed from a first observation point and receive first image data representing a first set of one or more images of one or more objects within the first geographic area. The first set of images includes a first image of a first object viewed from a second observation point different than the first observation point. The plurality of instructions also includes instructions that cause the one or more processors to display the first set of one or more images, receive a request for map information corresponding to a revised geographic area, and display a revised digital map. The revised geographic area does not include the first object. The plurality of instructions further includes instructions that cause the one or more processors to receive second image data image data representing a second set of one or more images of one or more objects within the revised geographic area. The second set of images includes a second image of a second object viewed from a fourth observation point different than the third observation point. The second image is different than the first image. The plurality of instructions further includes instructions that, after the revised digital map is displayed, cause the one or more processors to transition from the display of the first set of images to a display of the second set of images by concurrently displaying at least a portion of the first image and at least a portion of the second image for a perceivable amount of time, and, upon completion of the transition from the display of the first set of one or more images to the display of the second set of one or more images, display the second set of images but not the first image.

In another example embodiment, a computer-implemented method for transitioning between images supplementing a map display includes displaying via a user interface a digital map of a first geographic area viewed from a first observation point and receiving first image data representing a first set of one or more images of one or more objects associated with the first geographic area. The first set of images includes a first image of a first object viewed from a second observation point different than the first observation point. The method also includes displaying via the user interface the first set of one or more images, receiving via the user interface a request for map information corresponding to a revised geographic area, displaying via the user interface a revised digital map including a visual representation of the revised geographic area viewed from a third observation point, and receiving second image data representing a second set of one or more images of one or more objects associated with the revised geographic area. The revised geographic area does not include the first object. The second set of one or more images includes a second image viewed from a fourth observation point different than the third observation point. The second image is different than the first image. The method further includes, after the revised digital map is displayed, transitioning from displaying via the user interface the first set of one or more images to displaying via the user interface the second set of one or more images by concurrently displaying via the user interface at least a portion of the first image and at least a portion of the second image for a perceivable amount of time, and, upon completion of transitioning from displaying via the user interface the first set of one or more images to displaying via the user interface the second set of one or more images, displaying via the user interface the second set of one or more images but not the first image.

In another example embodiment, a method for transitioning between overlay images displayed with a map includes displaying on a screen a digital map of a first geographic area viewed from a first observation point. The method also includes identifying a first image of a first object located within the first geographic area and viewed from an observation point different than the first observation point, displaying the identified first image on the screen, receiving a request for map information from a user, and generating a revised digital map of a revised geographic area viewed from a second observation point and corresponding to the request for map information, where the revised geographic area does not include the first object. The method further includes displaying the revised digital map on the screen, identifying a second image of a second object located within the revised geographic area and viewed from an observation point different than the second observation point. After the revised digital map is displayed, the method includes transitioning the display of the first image to a display of the identified second image on the screen by using a transitioning effect to concurrently display at least a portion of the first image and at least a portion of the second image on the screen for a perceivable amount of time, and displaying only the second image on the screen upon completion of the transitioning from the first image to the second images.

### BRIEF DESCRIPTION OF THE DRAWINGS

FIG. 1 is a block diagram of an example display system that implements the techniques of the present disclosure to display a map on a display screen.

FIG. 2 is a flow diagram of an example method for displaying map information within a window on the display screen of a user interface.

FIG. 3 is a flow diagram of another example method for displaying map information within a window on the display screen of a user interface.

FIG. 4 is an example screenshot of a map displayed on the screen of a user interface.

FIG. 5 is an example screenshot of a map displayed on the screen of a user interface.

FIG. 6 is an example screenshot of a map displayed on the screen of a user interface.

FIG. 7 is an example screenshot of a map displayed on the screen of a user interface.

FIG. 8 is an example screenshot of a map displayed on the screen of a user interface.

FIG. 9 is a flow diagram of an example method for displaying changing map information.

FIG. 10 is a flow diagram of another example method for displaying changing map information.

FIG. 11 is an example screenshot of an initial map displayed on the screen of a user interface.

FIG. 12 is an example screenshot of a revised map displayed on the screen of a user interface.

FIGS. 13A-13F show example transitions from displaying a first image supplementing a map display to displaying a second image supplementing a map display.

### DETAILED DESCRIPTION

Using the techniques described herein, a map display system presents information for display on a screen in a manner that will enhance the map browsing experience of a user. As the user navigates to different areas using the map display system (e.g., by magnifying or panning the map display), different images (e.g., photographic images) of objects located within the various geographic regions represented by the maps are identified and displayed. The map display system transitions between the changing images by gradually and unobtrusively replacing old images with new images. The map display system may utilize any of various suitable transitioning effects, such as gradually fading a first image into a second image, gradually expanding a second image until it covers a first image, etc. In one implementation, the transitions between images may also be timed or delayed such that the transitions do not occur in a rapid, “flickering” manner as a user navigates to new areas of a map. By avoiding abrupt changes to the displayed images, a user's attention is less likely to be distracted from the map itself.

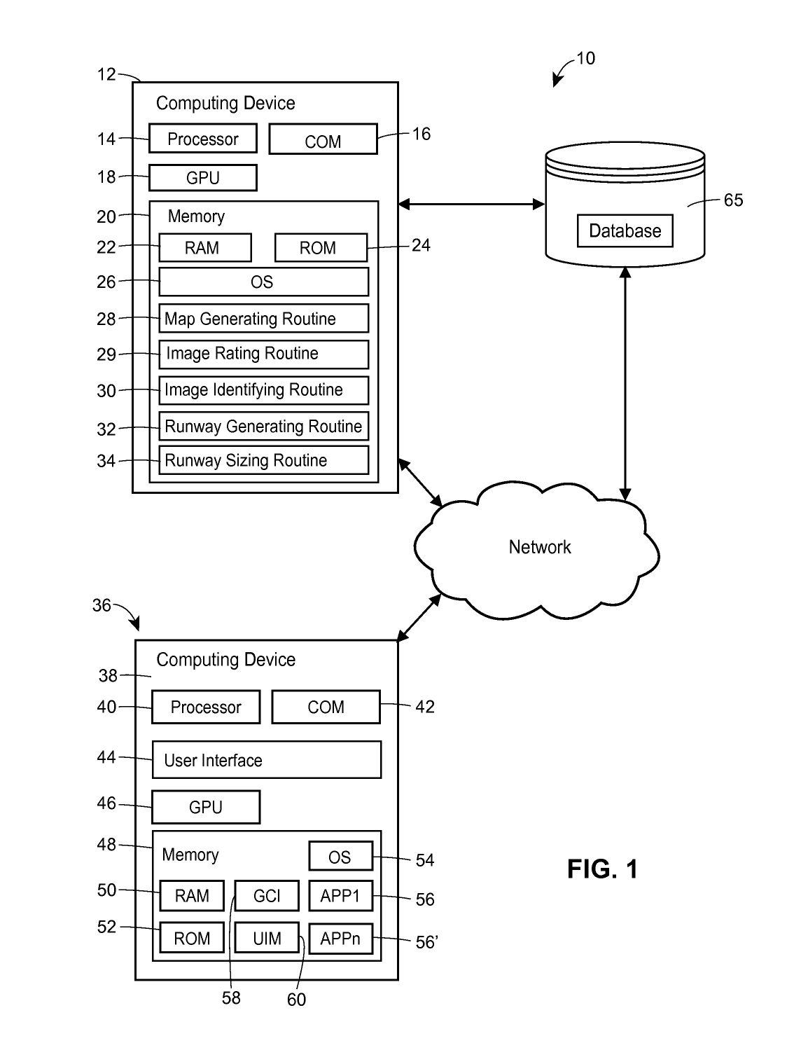

An example map display system 10 capable of implementing some or all of the techniques herein described is shown in FIG. 1. The map display system 10 includes a computing device 12. The computing device 12 is shown to be a server device, e.g., computer, but it is to be understood that the computing device 12 may be any other type of computing device, including, and not limited to, a main frame or a network of one or more operatively connected computers. The computing device 12 includes various modules, which may be implemented using hardware, software, or a combination of hardware and software. The modules include at least one central processing unit (CPU) or processor 14, a communication module (COM) 16, and a graphics processing unit (GPU) 18. The communication module 16 is capable of facilitating wired and/or wireless communication with the computing device 12 via any known means of communication, such as Internet, Ethernet, 3G, 4G, GSM, WiFi, Bluetooth, etc.

The computing device 12 also includes a memory 20, which may include any type of memory capable of being incorporated with the computing device 12, including random access memory 22 (RAM), read only memory 24 (ROM), and flash memory. Stored within the memory 20 is an operating system 26 (OS) and one or more applications or modules. The operating system 26 may be any type of operating system that may be executed on the computing device 12 and capable of working in conjunction with the CPU 14 to execute the applications.

One application 28 is a map generating application or routine that is capable of generating a map for display on a screen. The map generating application 28 is stored in memory 20 and may include additional routines or cooperate with additional routines to facilitate the generation and the display of map information. The additional routines may use location-based information associated with the geographic region to be mapped. In particular, the location-based information may be photographic images of objects that are physically located within or near the geographic region to be mapped. The photographic images may be stored in one or more memories, databases 65, or repositories accessible to the map rendering system.

An image identifying routine 30 may identify all the photographic images associated with objects located within the geographic region represented by the map that are accessible to the computing device 12. A runway generating routine 32 may cooperate with the image identifying routine 30 to create a runway or strip of images associated with the objects located within the mapped area. The runway generating routine 32 may include or cooperate with an image rating routine 29, wherein visual signals are used to rate the identified photographic images. The visual signals include one or more of the following: image type, object location, image quality, image popularity, map viewing mode, viewer location, and search term. The runway generating routine 32 may also include or cooperate with a runway sizing routine 34, wherein the size or dimension of the runway or at least one image therein is determined for displaying on a screen.

The generated map and runway are sent via the communication module 16 from the computing device 12 to a display system 36. The map and runway may be sent to the display system 36 individually or together, at the same time or at a different time. The display system 36 includes a computing device 38 such as a computer, tablet, or phone. The computing device 38 of the display system 36 is communicatively connected to the computing device 12 of the map display system 10 in a client-server relationship wherein the computing device 10 may be described as the server device and the computing device 38 may be described as the client device.

In one example embodiment, the client computing device 38 includes a processor (CPU) 40, a communication module (COM) 42, a user interface (UI) 44, and a graphic processing unit (GPU) 46. The client computing device 38 also includes a memory 48, which may include any type of memory capable of being incorporated with the client computing device 38, including random access memory 50 (RAM), read only memory 52 (ROM), and flash memory. Stored within the memory 48 is an operating system (OS) 54 and at least one application 56, 56′, both of which may be executed by the processor 40. The operating system 54 may be any type of operating system capable of being executed by the client computing device 36. A graphic card interface module (GCI) 58 and a user interface module (UIM) 60 are also stored in the memory 48. The user interface 44 may include an output module, e.g., screen 62 (not shown in FIG. 1) and an input module (not shown), e.g., keyboard, mouse, microphone. At least one of the applications 56, 56′ is capable of facilitating display of the map, runway, and photographic images received from the computing device 12 onto the screen 62.

In one example implementation, the application 56 is a web browser that controls a browser window provided by the OS 54 and displayed on the user interface 44. During operation, the web browser 56 retrieves a resource, such as a web page, from a web server (not shown) via a wide area network (e.g., the Internet). The resource may include content such as text, images, video, interactive scripts, etc. and describe the layout and visual attributes of the content using HTML or another a suitable mark-up language. Additionally, the resource requests that a portion of the browser window be allocated for display of map data and images on a runway, and provides an application programming interface (API) for accessing the map data and the image data from the computing device 12. Once the computing device 36 receives the resource, the application 56 displays the received content in the browser window, allocates a portion of the window in the form of an embedded window for display of map data and the runway with images, and executes the API to retrieve the map data and the image data and render the received data within the embedded window. Thus, according to this implementation, the computing device 12 specifies how map data is to be displayed as well as how the images are to be displayed over (or next to) the map image within the embedded window on the computing device 36. In other words, the application 56 obtains map data and image data from the same resource and renders both types of data within the same window using the same API, according to this example implementation.

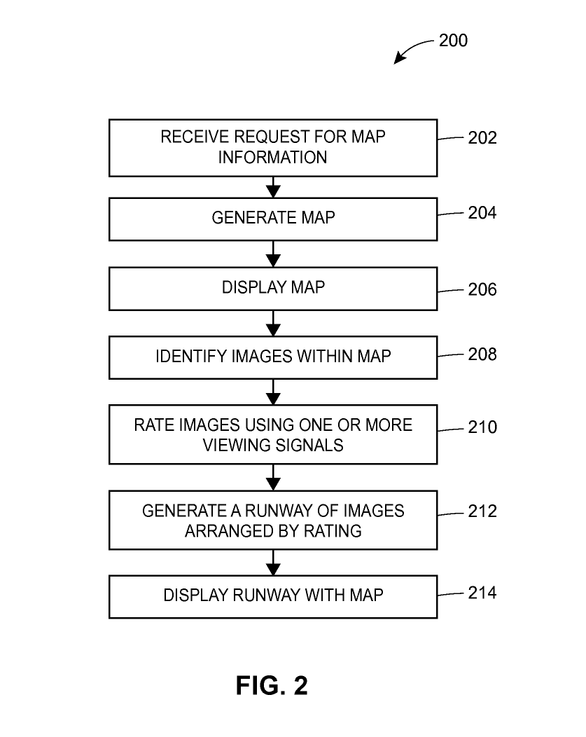

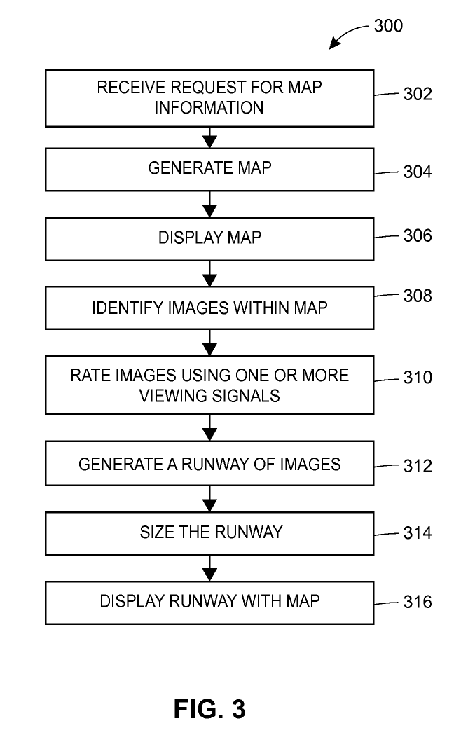

Several example methods for facilitating the display of overlay imagery associated with a map on an electronic device, which may be implemented by the components described in FIG. 1, are discussed next with reference to FIGS. 2 and 3. As one example, the methods may be implemented as computer programs stored on a tangible, non-transitory computer-readable medium (such as one or several hard disk drives) and executable on one or several processors. Although the methods shown in FIGS. 2 and 3 can be executed on individual computers, such as servers or personal computers (PCs), it is also possible to implement at least some of these methods in a distributed manner using several computers, e.g., using a cloud computing environment.

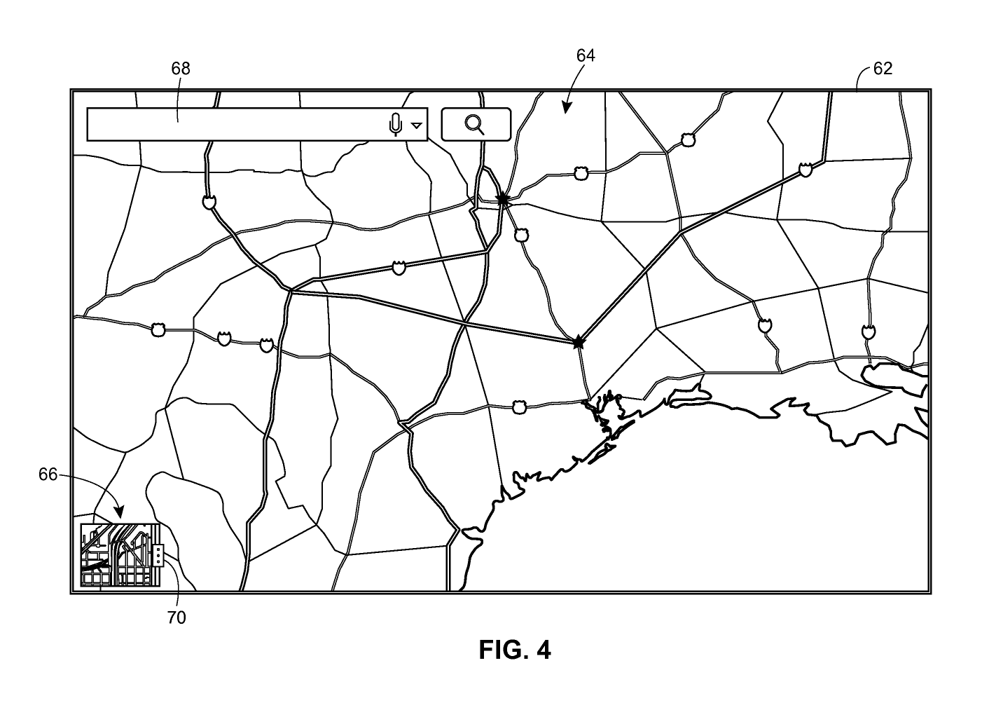

FIG. 2 is a flow diagram of an example method 200 for use in displaying overlay imagery associated with a map. The method 200 may be implemented in the map display system 10 shown if FIG. 1. In one example embodiment, the method 200 may be part of one or more routines stored in the memory 20. A request for map information is received at the computing device 12 (block 202). The request for map information may be initiated in a variety of forms. In one instance, a search request may be submitted by the user inputting a search term into a search box 68 on the display screen 62 (see FIGS. 4-8) of the client computing device 38. The request for map information may also be initiated by the user panning and/or zooming in and/or out of the map displayed on the screen 62, thereby changing the segment of the geographic area of the map represented and made visible on the screen.

In response to the request for map information received at the computing device 12, a map is generated by the map generating routine (block 204). The generated map may include map symbols representing information corresponding to objects located within and/or near the area represented by the map, such as natural and man-made structures, and locations, e.g., cities, towns, streets, etc. Map information corresponding to the generated map is sent via the communication module 16 to the client computing device 38 from which the request for map information was received. The client computing device 38 receives the generated map information via the communication module 42 and the generated map information is then displayed via the CPU 40, GPU 46, UI 44, and/or UIM 60 on the screen 62 (block 206).

Some objects located in or near the geographic area represented by the map may be represented by a symbol displayed within the map. Some objects located in or near geographic area represented by the map may also have one or more corresponding photographic images accessible to the computing device 12. The corresponding photographic images may be stored within an electronic data collection storage component internal or external to the computing device 12, for example, memory 20 of the server computing device 12 and photographic image repositories such as database 65. The server computing device 12 identifies photographic images corresponding to objects located in or near the map shown on the screen (block 208) and rates the identified images based on the photogenic features of the photographic image (block 210).

The aesthetic quality of the photographic images may be quantified by evaluating one or more viewing signals associated with the photographic image and/or the viewing aspects of the user. Each of the viewing signals may be proportionally or disproportionally weighted. A rating associated with each of the viewing signals may be assessed to each image and/or an overall rating for the photographic image may be calculated based on one or more of the viewing signals. The higher the score or rating a photographic image receives with respect to the viewing signals, the more likely it is that the user would be interested in viewing the image.

The one or more viewing signals that may be used to rate or assess the identified photographic images include image type, object location, image quality, image popularity, map viewing mode, user location, and search term. Image type generally includes the file format of the photograph and whether the photograph is a regular or special photograph, e.g., panoramic. For example, with respect to image type, a photographic image having a panoramic type may generally receive a higher rating as compared to a photographic image having a regular type. Object location generally relates to the geographical location of the object associated with the photographic image. For example, with respect to object location, a photographic image having a geographical location near the region being represented by the map displayed on the screen may generally receive a higher rating as compared to a photographic image having a geographical location farther from the region being represented by the map. Image quality generally includes the contrast, color, and/or definition, e.g., amount of pixels, of the photographic image. For example, with respect to image quality, a photographic image having more pixels and color contrast may generally receive a higher rating as compared to a photographic image having less pixels and less color contrast. Image popularity generally includes the consideration of user ratings and/or commentary that may be acquired from social networks, image repositories, etc. For example, with respect to image popularity, a photographic image having a higher viewer rating may generally receive a higher rating as compared to a photographic image having a lower viewer rating. Map viewing mode includes the type of viewing mode the user is utilizing while viewing the map, such as map mode, satellite mode, street-level mode. Map viewing mode may also include the consideration of the zoom level being used by the user. For example, viewing the map at a closer or nearer elevation may indicate that the user is more interested in viewing imagery as compared to transportation routes. User location includes consideration of the location where the viewer is viewing the map. For example, if the user is located far away from the location being represented by the map, the user may be interested in viewing photographic images of objects frequently associated with tourists and sightseeing. Search term generally pertains to the type of search term used in a search initiated by the user. For example, if the search term is an object widely known for its aesthetic features, such as a statue or fountain, the user may be interested in viewing images of other visually appealing objects.

A strip or runway of the identified photographic images is generated by the computing device 12 (block 212) and the runway of images is sent to the client computing device 38 and displayed on the screen 62 along with the generated map (block 214). The photographic images may be arranged within the runway in a sequence determined by the respective rating of each photographic image, e.g., highest to lowest overall rating, highest to lowest rating of a specified viewing signal or group of viewing signals.

FIG. 3 is a flow diagram of an example method 300 for use in displaying overlay imagery associated with a map. The method 300 may be implemented in the map display system 10 shown if FIG. 1. In one example embodiment, the method 300 may be part of one or more routines stored in the memory 20. A request for map information is received at the computing device 12 (block 302). The request for map information may be initiated in a variety of forms. In one instance, a search request may be submitted by the user inputting a search term into a search box 68 on the display screen 62 (see FIGS. 4-8) of the client computing device 38. The request for map information may also be initiated by the user panning and/or zooming in and/or out of the map displayed on the screen 62, thereby changing the segment of the geographic area of the map represented and made visible on the screen.

In response to the request for map information received at the computing device 12, a map is generated by the map generating routine (block 304). The generated map may include map symbols representing information corresponding to objects located within and/or near the area represented by the map, such as natural and man-made structures, and locations, e.g., cities, towns, streets, etc. Map information corresponding to the generated map is sent via the communication module 16 to the client computing device 38 from which the request for map information was received. The client computing device 38 receives the generated map information via the communication module 42 and the generated map information is then displayed via the CPU 40, GPU 46, UI 44, and/or UIM 60 on the screen 62 (block 306).

Some objects located in or near the geographic area represented by the map may be represented by a symbol displayed within the map. Some objects located in or near geographic area represented by the map may also have one or more corresponding photographic images accessible to the computing device 12. The corresponding photographic images may be stored within an electronic data collection storage component internal or external to the computing device 12, for example, memory 20 of the server computing device 12 and photographic image repositories such as database 65. The server computing device 12 identifies photographic images corresponding to objects located in or near the map shown on the screen (block 308) and rates the identified images based on the photogenic features of the photographic image (block 310).

The aesthetic quality of the photographic images may be quantified by evaluating one or more viewing signals associated with the photographic image and/or the viewing aspects of the user. Each of the viewing signals may be proportionally or disproportionally weighted. A rating associated with each of the viewing signals may be assessed to each image and/or an overall rating for the photographic image may be calculated based on one or more of the viewing signals. The higher the score or rating a photographic image receives with respect to the viewing signals, the more likely it is that the user would be interested in viewing the image. As described earlier with respect to the example method shown in FIG. 2, the one or more viewing signals that may be used to rate or assess the identified photographic images include image type, object location, image quality, image popularity, map viewing mode, user location, and search term.

A strip or runway of the identified photographic images is generated by the computing device 12 (block 312). The runway of images is then sized (block 314) before being sent to the client computing device 38 and displayed on the screen 62 along with the generated map (block 316). The size of the runway, e.g., photographic images within the runway, may be determined in relation to the ratings assessed to one or more of the photographic images contained within the runway. In particular, if the cumulative rating of all the ratings associated with the photographic images of the runway exceeds a threshold amount, the size of the photographic images displayed on the screen may be larger in comparison to when the cumulative score of the ratings does not exceed the threshold amount.

FIGS. 4-8 illustrate several example interactive screenshots that may be displayed on the screen 62 of the client computing device 38 as a result of the example systems and methods described herein. In general, the computing device 12 may generate information for a map 64 and send the map information to the client computing device 38 for display. The map 64 may typically be displayed at the computing device 38 via a browser application, but may be displayed using a standalone application or another type of application as well. Depending on the configuration of the client computing device 38, the user may interact with the map 64 via the user interface 44 and UIM 60, e.g., a mouse, a touchpad, a keyboard, a touch screen, a voice input device. The map 64 may be displayed in a variety of user-selectable map viewing modes including map mode, satellite mode, and street-level mode. The user may change or switch the map viewing mode by any known user interface technique, such as, drop-down menus and keystroke commands. The dimensions of the map 64 may be adjusted by the user via known UI adjustment mechanisms typically used for adjusting window frames displayed on a screen, such as maximizing and minimizing boxes located in the frame of the window (not shown).

In FIGS. 4-8, the runway 66 is displayed near the bottom of the screen 62 and atop the map 64, however it is to be understood that the runway map be positioned anywhere on the screen and not atop the map, for example. The runway 66 may be displayed in more than one size and includes at least one selectable photographic image or thumbnail. The photographic images within the runway 66 may correspond to one or more objects that are physically located in or near the geographic area being represented by the map 64 displayed on the screen 62. Photographic images of photogenic objects may be more likely to be included in the runway 66. In other words, images of objects that are visually attractive (i.e., as a subject of photography) may be more likely to be rated higher in terms of the viewing signals and therefore may be more likely to be included in the runway 66. For example, an object that is commonly considered a tourist attraction may be more likely to be photographed and shared in social media and repositories. Many of the photographic images corresponding to such an object are also likely to be of a high quality. Such photographic images are therefore likely to be rated higher in regard to the viewing signals as compared to an object that is not commonly considered to be a tourist attraction, such as a bus stop or a nondescript storefront.

Selection by the user of one of the photographic images in the runway 66 will change the display of the map 64 shown on the screen 62. For example, upon the selection of one of the photographic images in the runway 66, the selected photographic image will be displayed on the screen. In addition, one of the images within the runway may be selectable as an entry point into a different viewing mode available to the user. For example, selection of such an entry point may provide the user with the ability to view the map in a different map viewing mode, e.g., satellite view, street-level view. If the street-level viewing mode is selected by the user, the map will be displayed as if the user was positioned on the street-level. Further navigation by the user within the map while in the street-level viewing mode will display images on the screen 62 in a perspective as if the user was moving about on the ground.

In the example screenshot illustrated in FIG. 4, the screenshot includes the map 64 shown in map mode, wherein the features depicted within the map are shown in a traditional road-map type format identifying objects, e.g., natural and man-made structures, such as roads, railroads, hills, rivers, lakes, and towns. The user may begin the map viewing session by starting the map application. Initially, the user may use the user interface 44 of the client computing device 38 to request map information by entering a search team into a search text box 68. The user may also request map information by panning the map 64 displayed on the screen 62 or by zooming in or out of the map. In response to the user's request for map information, images of objects physically located in or near the geographic area represented by the map displayed on the screen are identified and rated as described earlier with respect to FIGS. 2 and 3, for example. The runway 66 of identified images is sent to the client computing device 38 and displayed atop the map 64. In the example screenshot illustrated in FIG. 4, the runway 66 includes one user-selectable image, which may be an entry point for selecting or changing the viewing mode. Selection by the user of the image shown in the runway 66 in FIG. 4 will enable the user to change the display of the map to another map viewing mode, such as a satellite mode, wherein the map 64 will change to a photograph taken from an elevation above the geographic region represented by the map.

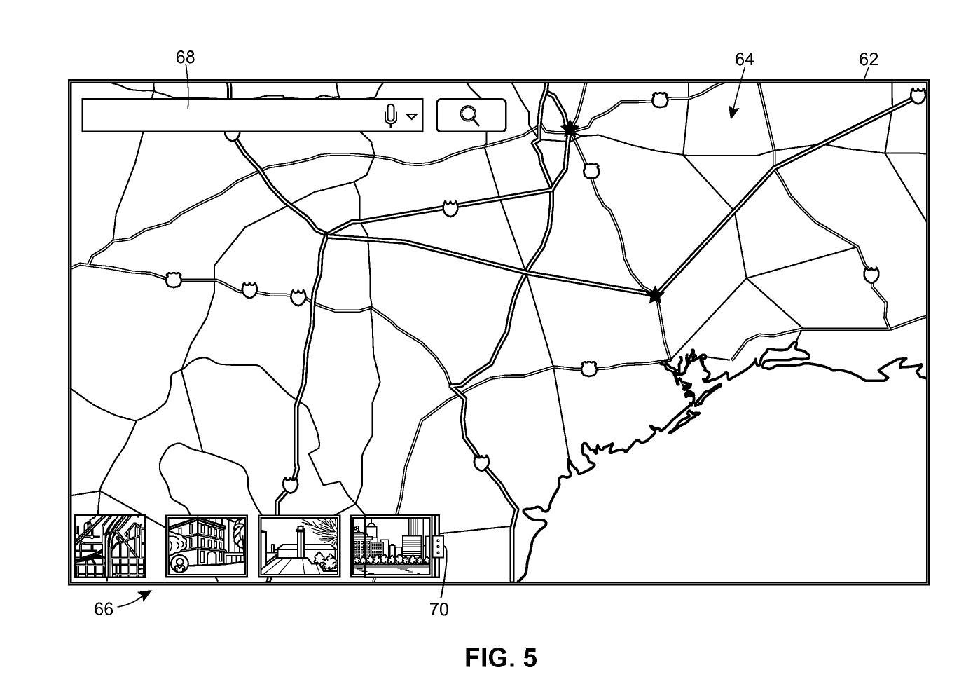

Changing the area of the map 64 shown on the screen 62 by panning or zooming may likely affect what objects are located within or near the geographic area being represented by the map shown on the screen. The addition or removal of objects associated with the map 64 may therefore affect the corresponding identified photographic images included within the runway 66. As a result, the rating determined for each object's photographic image may change due to the corresponding changes in the viewing signals, e.g., location of object, map viewing mode, etc. As will be explained in more detail below, a user-selectable tab 70 allows a user to set the size of the runway 66. In the example screenshot illustrated in FIG. 5, the viewer has slightly increased the zoom level as compared to the screenshot shown in FIG. 4. As the segment of the map displayed on the screen changes from FIG. 4 to FIG. 5, the amount of objects located in or near the different segment of the map shown on the screen may increase or decrease. As such, the runway 66 shown in FIG. 5 may include more photographic images than the runway shown in FIG. 4.

FIG. 6 illustrates an example screenshot after the user has zoomed slightly further into the map shown in FIG. 5. In FIG. 6, the runway 66 appears larger across the bottom of the map because one or more of the viewing signals have been modified and the ratings of the photographic images may have likely changed. In FIG. 6, the user has zoomed into the map, which may be perceived as the user being more concerned with viewing images of objects associated with the map and less concerned with the routes of transportation or an overview of surrounding terrain. This perception is reflected in the determination of the rating assessed to each photographic image associated with an object located within the geographic area represented by the map. Through the use of the viewing signals and the ratings of the viewing signals, the user viewing FIG. 6 may be perceived to be more interested in viewing photographic images, and therefore, those photographic images likely to be of interest to the user are shown more prominently, e.g., larger, in the runway 66 in FIG. 6 as opposed to the images in the runway shown in FIGS. 4 and 5.

Because the photographic images and the runway are displayed, at least in part, in response to the viewing characteristics employed by the user, the changes to the runway and the photographic images may appear to intuitively occur. In particular, as the user browses or navigates the map 64 displayed on the screen 62, photographic images of objects located in or near the geographic area depicted by the map are identified and rated based on one or more of the viewing signals. The rated photographic images are arranged in the runway and sent to the client computing device 38 to be displayed on the screen 62 in conjunction with the map 64. Further changes by the user to the view of the map 64 displayed on the screen 62, which result in changes to the ratings of identified photographic images, will be reflected by the changes to the photographic images included or removed from the runway 66.

The runway 66 may include one or more user interfaces to provide additional display features to enhance the user's control over the map viewing experience. One display feature for the runway 66 allows the user to deactivate the resizing of the display of the runway 66 on the screen 62 that occurs in response to the ratings determined for the identified photographic images contained within the runway. More specifically, the user-selectable tab 70 or the like is operatively coupled to the user interface module 60 and may be affixed to an edge of the runway 66. By selecting the tab 70, the user may fix the size of the runway 66 displayed with the map 64 and thereby prevent the size of the runway 66 from changing in response to the determination of the ratings associated with the identified photographic images contained within the runway. In other words, fixing the size of the runway will essentially suspend operation of the runway sizing routine 34 wherein the size of the runway will remain constant during the map viewing session, or until such time that the user reinstates the runway sizing routine. The user may select, via the tab 70, to fix the size of the runway 66 to remain in the smaller (see FIG. 5) or larger (see FIG. 6) size.

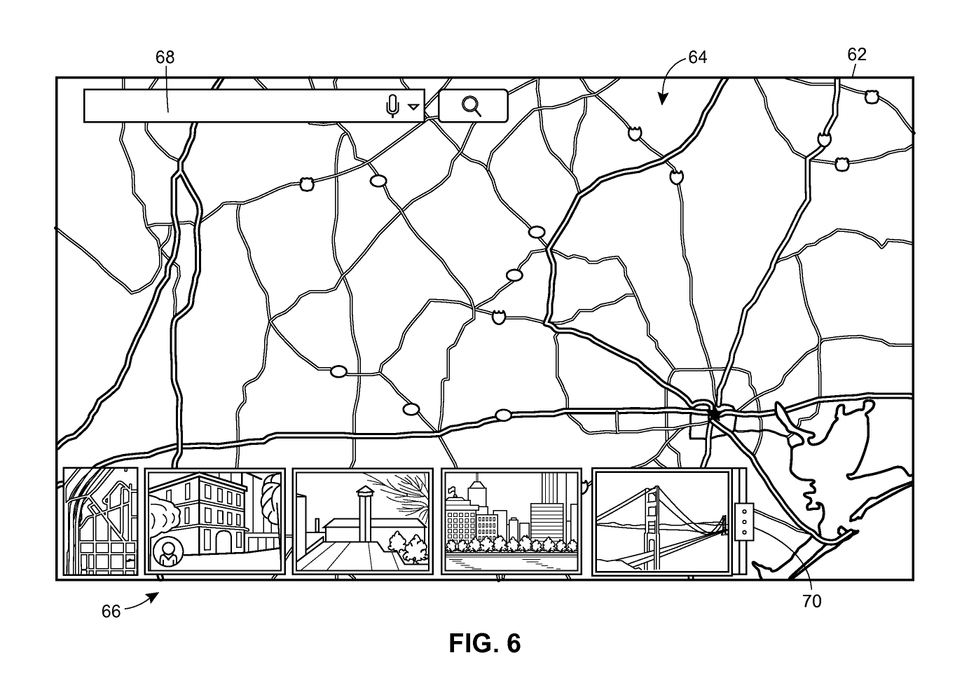

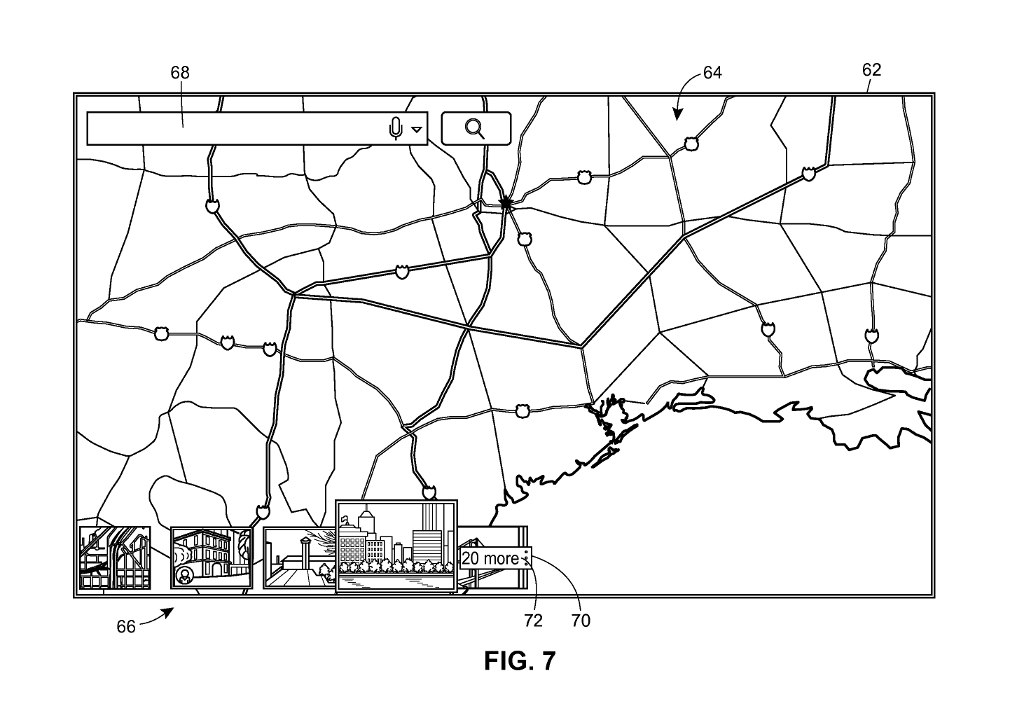

The runway 66 may also provide the user with the ability to temporarily enlarge a pre-selected thumbnail image contained within the runway 66. See for example, the runway 66 illustrated in FIG. 7. The user may pre-select the thumbnail image by using the user interface 44 and UIM 60 to highlight the desired thumbnail image. The thumbnail image may be highlighted by the user by hovering the mouse pointer over the thumbnail image or by pressing the tab key on the keyboard to pre-select or highlight the thumbnail image.

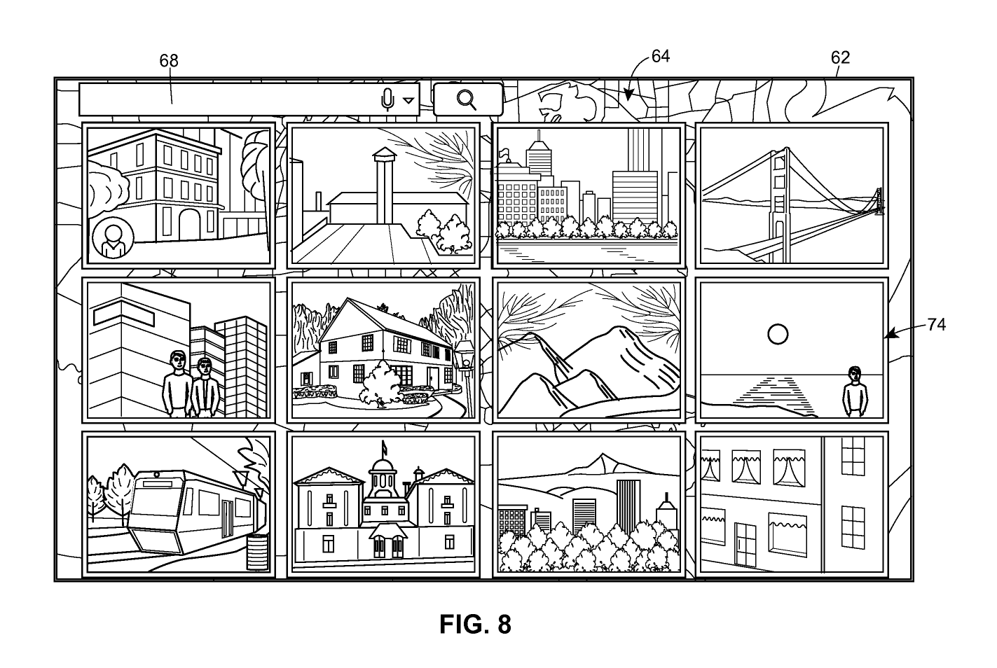

In instances where there are many photographic images within the runway 66, the runway 66 may extend beyond the width of the screen. The user may horizontally scroll the runway 66 to bring thumbnail images initially not displayed on the screen 62 into view on the screen. In addition, the runway may also provide the user with the ability to display all the photographic images contained within runway 66 in a grid view. The runway 66 may include a user-selectable composite view image or an indicator 72 associated with the runway. The indicator 72 may indicate the amount of photographic images contained within the runway 66. The user may select the indicator 72 to bring about the grid display of the photographic images onto the screen 62 as shown in FIG. 8, for example. Selection of one of the photographic images displayed in the grid will change the display on the screen to show the selected photographic image.

In some embodiments, the various sizes of images may be downloaded to the client computing device 38 so that user-initiated runway changes can be accommodated without network access to the computing device 12. Although the embodiments illustrated show image selection and arrangement performed on the server side computing device 12, advancements in client side computing device 38 memory capacity, computing power, and network connectivity are such that these functions are reasonably contemplated as being performed at the client side computing device 38 in some embodiments.

It is apparent from the description above that the user's map-viewing experience can be enhanced by the use of the runway of photographic images displayed in combination with the map, wherein the photographic images compiled within the runway are determined in conjunction with the user's viewing characteristics. Alternatively (or additionally), the user's map-viewing experience may be enhanced by providing a viewing environment in which runway images are transitioned in a subtle, unobtrusive manner, as described hereafter.

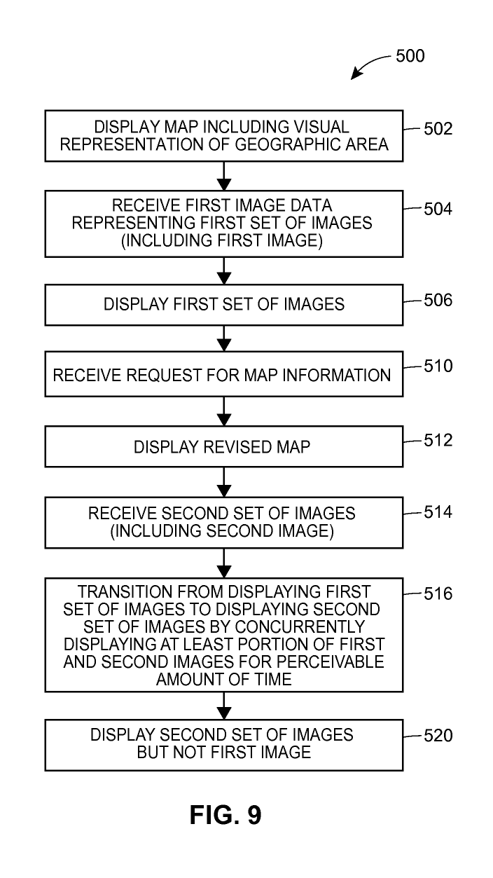

FIG. 9 is a flow diagram of an example method 500 for displaying changing map information. The method 500 may be implemented in any suitable computing device, including a client device such as computing device 38 of FIG. 1. For ease of explanation, the method 500 is described below with reference to FIG. 1, in an example embodiment where the method 500 is implemented in computing device 38. All or a part of the method 500 may be implemented by one or more processors (e.g., CPU 40 and/or GPU 46 of computing device 38) executing computer instructions stored on a computer-readable memory (such as a hard disk drive, an optical disk, RAM or ROM memory, etc.). In some implementations, the executed instructions include compiled instructions. For example, the instructions may include instructions of a plug-in that is downloaded to computing device 38 using a browser application (e.g., application 56). The plug-in may be stored in memory 20 of computing device 12 (or at a location referenced by a web page stored in memory 20 of computing device 12, etc.), and downloaded to memory 48 of computing device 38, for example. As another example, the instructions may include instructions of an executable application, such as an application installed by a user in memory 48 of computing device 38 (e.g., application 56). Alternatively or additionally, the instructions may include instructions that are interpreted at run-time. For example, the instructions may include scripting language instructions (e.g., JavaScript instructions) that are included in a web page stored in memory 20 of computing device 12. The computing device 38 may access the web page with the scripting language instructions using a browser application (e.g., application 56), for example.

At block 502, a map is displayed. The displayed map includes a visual representation of a particular geographic area viewed from a first observation point. The geographic area may be an area determined based on navigation inputs (e.g., an address, or panning and/or zooming commands) previously entered by a user of computing device 38, or may be a default area (e.g., a geographic area corresponding to a default map that is displayed when a web site is first visited), for example. The first observation point may be a function of both the coordinates of the center of the displayed map and the magnification/zoom level of the displayed map (e.g., as set by a user or according to a default setting). For example, a lower magnification/zoom level may correspond to a more distant observation point, allowing a map of a larger geographic area to be displayed, and panning the map display may cause the observation point to shift in the direction of the panning.

The map may be displayed via user interface 44 of computing device 38. For example, the map may be displayed on a screen of user interface 44, such as a computer monitor screen, a mobile device touch screen, etc. As used herein, “displaying” a map (or any other image, animation, graphic, etc.) may refer either to the end result of visually presenting the map (or image, animation, etc.) to a viewer on a screen, or to processing data in a manner that causes such a display. For example, in an embodiment where the method 500 is performed entirely by a processor executing instructions, the processor may display a map by causing the map to be depicted on a screen (e.g., by transmitting map display data to a user interface module, etc.).

In one implementation, the map display is generated based on map data received by computing device 38 from computing device 12 via communication module 42. The received map data may be data generated by map generating routine 28 of computing device 12, for example.

At block 504, first image data is received. The first image data represents a first set of one or more images of one or more objects (e.g., buildings, landmarks, etc.) within the geographic area of the map displayed at block 502. The first set of images includes at least a first image of a first object viewed from a second observation point. The second observation point is different than the first observation point corresponding to the map displayed at block 502. For example, if the first image is a photograph of the first object, the second observation point may be the position of an individual who used a camera to take the photograph from a nearby, terrestrial location. The images in the first set of images may be similar to the runway images discussed above. Moreover, the received first image data may be data previously identified by image identifying routine 30, and/or data previously generated by runway generating routine 32 and/or runway sizing routine 34, for example. In one implementation, the first image data is received by computing device 38 from computing device 12 via communication module 42.

At block 506, the first set of one or more images represented by the first image data received at block 504 is displayed. The first set of images is displayed via the same user interface (e.g., the same screen of user interface 44) via which the map is displayed at block 502. In one implementation, the display of the first set of images is generated at computing device 38 (e.g., using CPU 40 and/or GPU 46) based on the first image data received at block 504. The first set of images may be displayed at least in part simultaneously with the display of the map at block 502. For example, the first set of images may generally be displayed as shown in any the runway images illustrated in FIGS. 4-8.

At block 510, a request for map information is received. The request for map information may be received via a user interface (e.g., via a mouse, keyboard, touch screen, etc., of user interface 44). The request for map information corresponds to a revised geographic area. In various scenarios, for example, the request may be indicative of a magnification/zoom command, panning command, or address (e.g., street address, town name, zip code, etc.) entered by a user via the user interface, and may correspond to the particular geographic area targeted by the entered command or address. As one more specific example, in a scenario where a user enters a command to zoom into the map displayed at block 502 (e.g., by moving a cursor over a magnification icon displayed in a browser window and clicking a mouse button), the revised geographic area may consist of a smaller area than the geographic area represented by the map displayed at block 502. As another specific example, in a scenario where a user enters a command to pan the map displayed at block 502 in a particular direction (e.g., by moving a cursor over an arrow displayed in a browser window and clicking a mouse button), the revised geographic area may be centered on a different geographic location/coordinate than the geographic area represented by the map displayed at block 502.

At block 512, a revised map that includes a visual representation of the revised geographic area viewed from a third observation point is displayed via the user interface. The revised map is displayed via the same user interface (e.g., the same screen of user interface 44) via which the map is displayed at block 502 and the first set of images is displayed at block 506. The third observation point may be the same as or different than the first observation point corresponding to the map displayed at block 502. For example, the first and second observation points may be the same in a scenario where the request for map information (received at block 510) corresponds to a change of map modes (e.g., traditional to satellite mode), without panning or magnification. As another example, the first and second observation points may be different if the request for map information corresponds to a pan and/or magnification/zoom command.

In one implementation, the revised map display is generated based on revised map data received by computing device 38 from computing device 12 via communication module 42. The revised map data may be data previously generated by map generating routine 28 of computing device 12 based on the request for map information received at block 510. In one implementation, for example, computing device 38 transmits data indicative of the request for map information to computing device 12, where map generating routine 28 utilizes the received data along with corresponding data from a map information storage to generate the revised map data. Computing device 12 may then transmit the revised map data to computing device 38 for use in generating the display of the revised map. The revised map may be displayed on the screen at one time or, in some scenarios and/or implementations, may be displayed piecemeal as the revised map data is received at computing device 38.

At block 514, second image data is received. The second image data represents a second set of one or more images of one or more objects within the revised geographic area of the revised map displayed at block 512. The second set of images includes at least a second image of a second object viewed from a fourth observation point. The second image is different than the first image, and the second set of images does not include the first image. Moreover, the fourth observation point is different than the third observation point corresponding to the revised map (e.g., the fourth observation point may correspond to the position of a person who had photographed the second object from a nearby, terrestrial location). The images in the second set of images may be similar to the runway images discussed above. In various implementations and/or scenarios, the number of images in the second set of images may be more than, less than, or equal to the number of images in the first set of images. Moreover, one or more images in the second set of images may be the same as one or more images (other than the first image) in the first set of images. The received second image data may be data previously identified by image identifying routine 30 (e.g., based on the bounds of the revised geographic area), and/or data previously generated by runway generating routine 32 and/or runway sizing routine 34, for example. In one implementation, the second image data is received from computing device 12 via communication module 42.

At block 516, the display of the first set of one or more images is transitioned to a display of the second set of one or more images. Transitioning between the displays includes at least replacing the first image of the first set of images with the different, second image of the second set of images. The transition may include other changes as well, such as replacing other images of the first set of images with other images of the second set of images, transitioning to a larger number of images (e.g., if the second set is larger than the first set), transitioning to a smaller number of images (e.g., if the second set is smaller than the first set), etc. In one scenario, images that are included in both the first set of images and the second set of images do not change position on the display (e.g., do not change position in a runway), in order to avoid distracting a viewer's attention from the map as the transition occurs, and/or to save processing power.

The transition of the display of the first image to the display of the second image proceeds according to a transitioning effect. The transitioning effect is a particular type of animation that includes a concurrent display of at least a portion of the first image and at least a portion of the second image for a perceivable amount of time (i.e., a time span making the concurrent display visually perceivable to a typical human viewer). In some implementations, the second image is intensified and/or the first image is faded during the perceivable time period. For example, the second image may increase from 0% intensity (i.e., no displayed image) to 100% intensity (i.e., a fully displayed image) while the first image decreases from 100% intensity to 0% intensity. Moreover, in some implementations, the size of the second image is increased and/or the size of the first image is decreased during the perceivable time period. For example, the second image may increase from 0% of its full size (i.e., no displayed image) to 100% of its full size (i.e., a fully displayed image) while the first image decreases from 100% of its full size to 0% of its full size. Further, in some implementations, the second image is progressively revealed and/or the first image is progressively covered during the perceivable time period. For example, the first image may be progressively covered by the second image until the first image is entirely covered and/or the second image is fully displayed. Any suitable combination of the above techniques may be implemented with respect to the first and second images. For example, the second image may expand from 0% to 100% of its full size while the second image fades, the second image may be progressively revealed as the first image shrinks from 100% to 0% of its full size, etc. Moreover, more than one of the above techniques may apply to one or both of the first and second images. For example, the second image may expand in size and intensify while the first image shrinks and fades, etc.

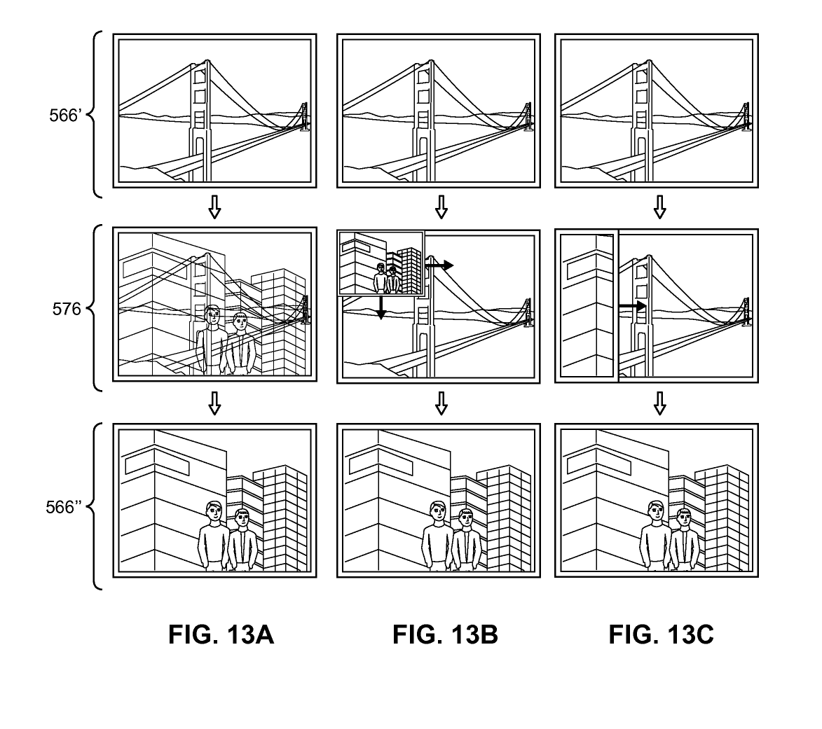

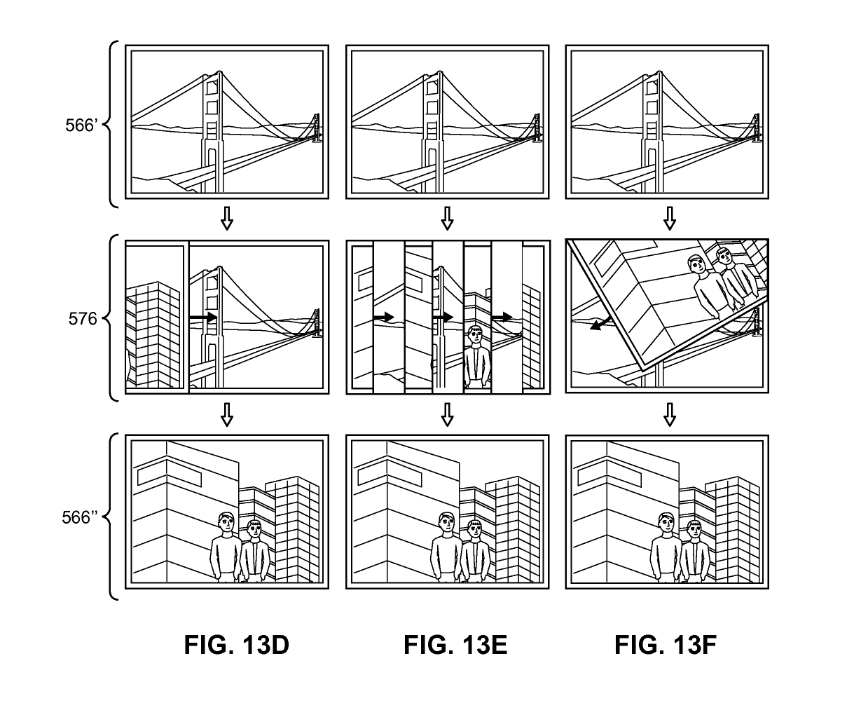

In addition, and simultaneously with any of the above techniques, transitioning between the displays may include shifting and/or rotating the first image and/or the second image. For example, the second image may be shifted such that it progressively covers the first image (e.g., by progressively sliding the second image, or an expanding portion of the second image, over the first image until the first image is entirely covered). As another example, the first image may be shifted such that it progressively reveals the second image (e.g., by sliding the first image, or a decreasing portion of the first image, from over the second image until the second image is fully displayed). As yet another example, the second image (or an expanding portion thereof) may be rotated such that it progressively covers the first image. Various example transitions are described below with reference to FIGS. 13A-13F.

The amount of time over which the concurrent display of the first and second images (or image portions) occurs is a time interval that, in addition to being perceivable to a viewer, is suitable for reducing or minimizing distractions to the viewer when navigating a map. For example, in various implementations, the perceivable amount of time is at least 0.25 seconds, at least 0.5 seconds, at least 1 second, at least 2 seconds, etc.

The transitioning of the display occurs via the same user interface (e.g., the same screen of user interface 44) via which the map is displayed at block 502, the first set of images is displayed at block 506, and the revised map is displayed at block 512. In one implementation, the animation corresponding to the transition effect is generated based on the first image data received at block 504 and the second image data received at block 514.

At block 520, upon completion of the transition at block 516, the second set of one or more images, but not the first image, is displayed. In addition to the first image, other images included in the first but not the second set of images (if any) may also be absent from the display upon completion of the transition. Once fully displayed, the second set of images may occupy substantially the same portion of the display area that was previously occupied by the first images (e.g., a same runway overlaying the map display, as described above). In particular, the second image may, when fully displayed, be located in a display area that at least partially overlaps the display area of the first image when the first image was fully displayed (e.g., in implementations where the second image progressively covers the first image). Alternatively, the fully displayed second image may be located in a different display area than the previously displayed first image.

The transitioning effect animation may occur before, after, and/or simultaneously with the display of the revised map at block 512. At some point, however, the second set of images (including the second image) may be fully displayed along with the revised map (e.g., overlaying the revised map). In one implementation, the transition at block 516 does not start until after the revised map is fully displayed. In other implementations, the transition at block 516 does not start until at least a predetermined time interval after receiving the request for map information at block 510. For example, the transition from the first set of images to the second set of images may begin in response to a timer expiration, where the timer begins after a user has finished entering a navigation input (e.g., entering a zoom or pan command, etc.). Thus, in a scenario where a user repeatedly and rapidly clicks a “pan right” navigation control, for example, the images will not update until the user stops (or pauses for a sufficiently long time). Such techniques may prevent rapid changes to the images supplementing the map display as a user navigates from one area to another, and may allow a user to focus on the map itself with fewer distractions.

The steps of method 500 may occur in a different order than shown in FIG. 9. For example, receiving the first image data at block 504 and/or displaying the first set of images at block 506 may occur before and/or at the same time as, displaying the map at block 502. Similarly, receiving the second image data at block 514, transitioning from the display of the first set of images to the second set of images at block 516, and/or displaying the second set of images at block 520 may occur before and/or at the same time as displaying the revised map at block 512. Moreover, the method 500 may include additional steps not shown in FIG. 9. For example, the method 500 may include receiving map data representing a map prior to displaying the map at block 502. As another example, the method 500 may include transmitting (e.g., to computing device 12) data indicative of the request for map information and/or receiving (e.g., from computing device 12) revised map data in response (e.g., between blocks 510 and 512).

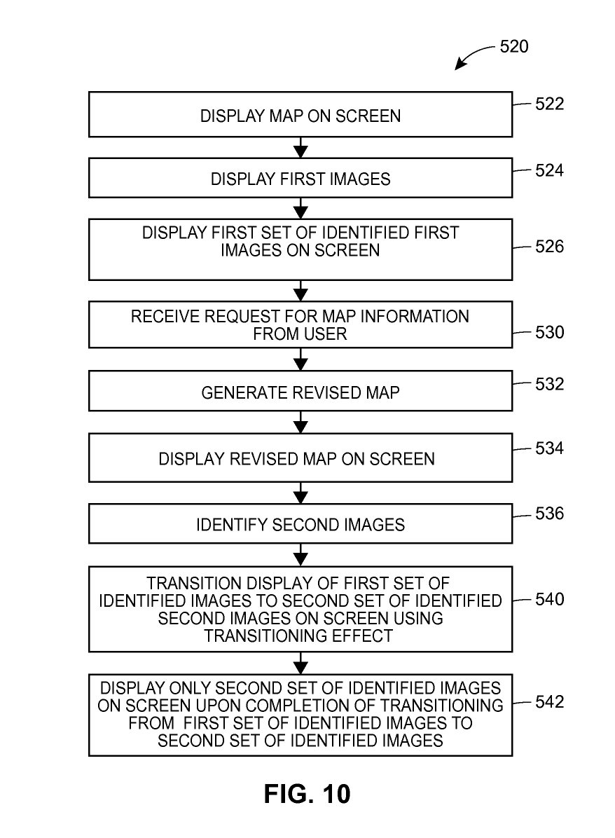

FIG. 10 is a flow diagram of another example method 520 for displaying changing map information. The method 520 may be implemented in any suitable computing device, including a server device such as computing device 12 of FIG. 1. For ease of explanation, the method 520 is described below with reference to FIG. 1, in an example embodiment where the method 520 is implemented in computing device 12. All or a part of the method 520 may be implemented by one or more processors (e.g., CPU 14 and/or GPU 18 of computing device 12) when executing computer instructions stored on a computer-readable memory (such as a hard disk drive, an optical disk, RAM or ROM memory, etc.). In some implementations, the executed instructions include compiled instructions. For example, the instructions may include instructions of an executable application, such as an application installed by a user in memory 20 of computing device 12.

At block 522, a map is displayed on a screen. The map includes a visual representation of a geographic area viewed from a first observation point. Block 522 may be similar to block 206 in method 200 of FIG. 2, for example. At block 524, first images of objects located within the geographic area, and viewed from observation points different than the first observation point, are identified. Block 524 may be similar to block 208 in method 200 of FIG. 2, for example. At block 526, a first set of the first images of objects identified at block 524 is displayed on the screen. Block 526 may be similar to block 214 in method 200 of FIG. 2, for example.

At block 530, a request for map information is received from a user. The request may include data indicative of a user input (e.g., navigation command) entered via user interface 44 of computing device 38, where computing device 12 receives the request data from computing device 38 via communication module 16, for example. Block 530 may be similar to block 202 in method 200 of FIG. 2, for example. At block 532, a revised map is generated. The revised map includes a visual representation of a revised geographic area viewed from a second observation point and corresponding to the request for map information received at block 530. Block 532 may be similar to block 204 in method 200 of FIG. 2, for example, and the second observation point may be the same as or different than the first observation point of the map displayed at block 522. At block 534, the revised map generated at block 530 is displayed on the screen. Block 534 may be similar to block 522, for example. At block 536, second images of objects located within the revised geographic area, and viewed from observation points different than the second observation point of the revised map, are identified. Block 536 may be similar to block 208 in method 200 of FIG. 2, for example.

At block 540, the display of the first set of identified images is transitioned to a second set of the identified second images on the screen by using a transitioning effect. According to the transitioning effect, at least a portion of the first set of identified images and at least a portion of the second set of identified images are concurrently displayed on the screen for a perceivable amount of time. Depending on the number of images in the first and second sets of images, and on the number of images that differ between the first and second sets of images, one or more images of the first set may transition to one or more images of the second set according to the transitioning effect. For each image that is replaced by a new image, the transitioning effect may be similar to any of the transitioning effects described above with reference to block 516 of FIG. 9, for example. Moreover, any of the transitioning effects described with reference to block 516 of FIG. 9 may be used for each extra image that is added without a corresponding previous image (e.g., in scenarios where the second set of images includes more images than the first set of images), and/or for each image that is removed without a corresponding replacement image (e.g., in scenarios where the second set of images includes fewer images than the first set of images). For example, in a scenario where the first set of images has one more image than the second set of images, the extra image of the first set may simply fade away for the duration of a perceivable amount of time, without being replaced by any corresponding image in the second set of images. Conversely, in an example scenario where the second set of images has one more image than the first set of images, the extra image of the second set may intensify until fully displayed after the perceivable amount of time, without any corresponding removal of an image from the first set of images.

At block 542, upon completing the transitioning from the first set of identified images to the second set of identified images, only the second set of identified images is displayed on the screen (i.e., the first set of images is absent from the display). It is to be understood, however, that images from the first set of identified images that are also included in the second set of identified images may still be displayed on the screen by virtue of being included in the second set of images, and that the display may continue to include other kinds of graphical content outside of the second set of images (e.g., outside of the runway), such as the revised map itself, navigation controls, etc.

The steps of method 520 may occur in a different order than shown in FIG. 10. For example, displaying the first set of the identified first images at block 526 may occur before and/or at the same time as displaying the map at block 522. Similarly, transitioning the display of the first set of images to the second set of images at block 540 and/or displaying only the second set of images at block 542 may occur before and/or at the same time as displaying the revised map at block 534. Moreover, the method 520 may include additional steps not shown in FIG. 10.

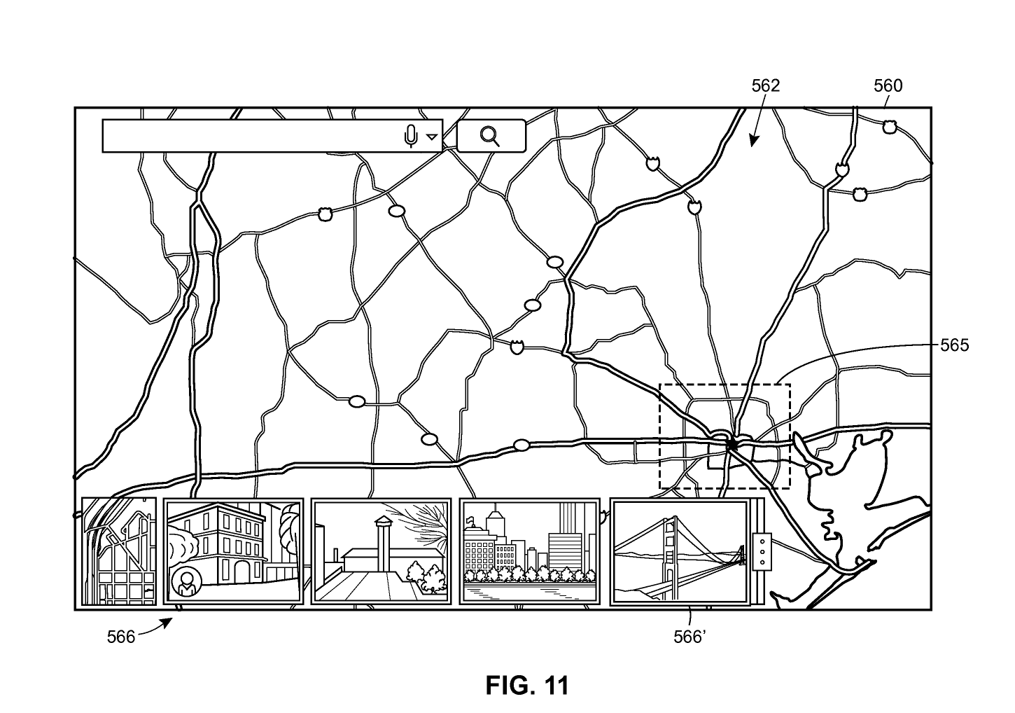

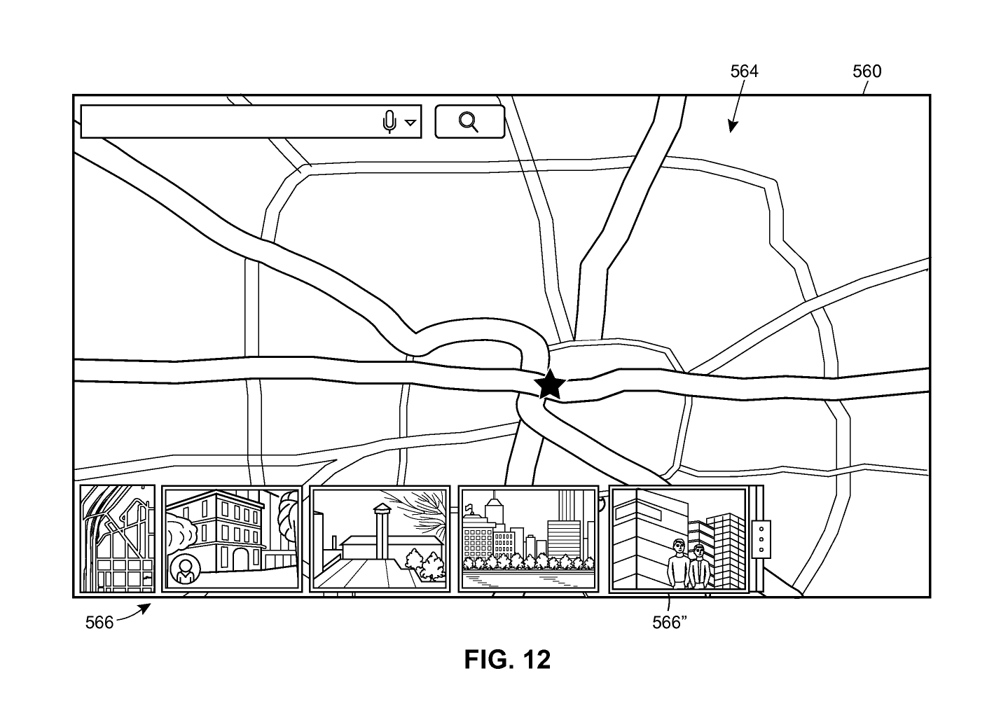

FIGS. 11 and 12 illustrate example screenshots displayed on a screen 560 of a computing device. In particular, FIG. 11 illustrates a screenshot at a first time when a first map 562 is displayed on screen 560, and FIG. 12 illustrates a screenshot at a second, later time when a user has navigated to a different geographic area represented by a revised map 564. More specifically, the revised map 564 in the example screenshot of FIG. 12 is displayed in response to the user zooming into the area represented by the rectangle 565 with a dashed outline in FIG. 11. The screen 560 may be the same as screen 62 of computing device 38 in FIG. 1, for example, and the displays shown in FIGS. 11 and 12 may be generated in a manner similar to the screenshots of FIGS. 4-8. While the map 562 and the revised map 564 are shown in a traditional map mode, other modes (e.g., satellite, street view) may be shown instead.

Shown at the bottom of each map is a runway 566 that includes a set of photographic images or thumbnails that corresponds to objects physically located within or near the geographic area represented by the respective map. The images in the runways may be images identified, generated, and/or displayed in accordance with the methods of FIG. 2 or 3, for example.

In the example screenshots of FIGS. 11 and 12, the runway 566 includes a first set of images when the first map 562 is displayed, and includes a second set of images when the revised map 564 is displayed. In the example shown, the first and second sets of images are identical except for a first image 566′ of the first set of images and a second image 566″ of the second set of images. In one scenario, for example, the first image 566′ corresponds to an object well outside of the magnified area 565 (and therefore not included in the runway 566 when revised map 564 is displayed), while the second image 566″ is within the geographic areas of both map 562 and revised map 564, but for other reasons is absent from the runway 566 when the first map 562 is displayed. For example, an image rating routine and/or runway generating routine (e.g., routines 29 and 32 of FIG. 1) may determine that the second image 566″ should not be included in the runway 566 with the first map 562 due to the zoom level corresponding to map 562, due to the second image 566″ having a lower rating than the first image 566′, etc. While only the images 566′ and 566″ differ in the sets of images corresponding to map 562 and revised map 564 in the example scenario shown, some or all of the other images may also differ in other scenarios. Moreover, the number of images in the runway 566 may increase or decrease when the display of map 562 changes to the display of revised map 564.

The transition from the first image 566′ to the second image 566″ occurs according to a transitioning effect, which includes an animation during which at least a portion of the first image 566′ and at least a portion of the second image 566″ are concurrently displayed for a perceivable amount of time (e.g., 0.5 seconds, 1 second, etc.). The transitioning effect may be similar to any of the transitioning effects described above with reference to block 516 of FIG. 9, for example. Specific examples of the transitions from the first image 566′ to the second image 566″ are illustrated in FIGS. 13A-13F. Each of FIGS. 13A-13F depicts a starting point of the transition at the top of the figure (where the first image 566′ is fully displayed and the second image 566″ is entirely absent), and an end point of the transition at the bottom of the figure (where the second image 566″ is fully displayed and the first image 566′ is entirely absent). Each of FIGS. 13A-13F also depicts a midpoint of the transition, at which an intermediate image 576 reflects an intermediate stage of the transition from the first image 566′ to the second image 566″. The intermediate image 576 represents a animation snapshot or frame that occurs during the concurrent display of the first image 566′ and the second image 566″ (or the portions thereof).

In the example transition of FIG. 13A, the first image 566′ is faded while the second image 566″ is intensified. Intermediate image 576 shows an animation frame in which both the first image 566′ and the second image 566″ are at roughly 50% intensity. In the example transition of FIG. 13B, the first image 566′ remains unchanged, except that the image 566′ is progressively covered by an expanding second image 566″. The bold arrows in FIGS. 13B-13F show the direction of expansion and/or movement of the second image 566″. As shown in FIG. 13B, the second image 566″ expands until the first image 566′ is completely obscured (i.e., is no longer displayed). Intermediate mage 576 shows an animation frame in which the second image 566″ has expanded enough to cover roughly one fifth of the first image 566′. In other embodiments, the second image 566″ may expand from any starting point, and may expand in any direction or directions (left/right/up/down) with respect to the viewer of the display. For example, FIG. 13C shows an example transition where the second image 566″ expands to the right, starting from the left side of the display area of the first image 566′. Moreover, the subject matter of the second image 566″ (e.g., buildings, people, etc.) may be progressively revealed as the second image 566″ expands (as shown in FIG. 13C), or may be decompressed as the second image 566″ expands (as shown in FIG. 13B).

As with FIG. 13C, FIG. 13D shows an example transition during which the first image 566′ remains unchanged (other than being progressively covered), and in which the second image 566″ expands to cover the first image 566′. In the transition shown in FIG. 13D, however, the second image 566″ has the appearance of sliding over the first image 566′, i.e., the subject matter of the second image 566″ appears to move/shift to a location over the first image 566′, rather than appearing to be motionless as in FIG. 13C. In an alternative embodiment, the transition of FIG. 13D instead has the appearance of sliding the first image 566′ to uncover the second image 566″, i.e., the subject matter of the first image 566′ appears to move/shift out from its initial location over the second image 566″.

FIG. 13E shows an example transition that may be similar to FIG. 13C or FIG. 13D, with the exception that multiple segments of the first image 566′ are progressively covered with multiple disjointed segments of the second image 566″ (i.e., multiple segments of the second image 566″ progressively expand, rather than just a single portion). The expanding segments of the second image 566″ may be “disjointed” in the sense that the continuity of the subject matter of the second image 566″ (or more specifically, of the portion of the subject matter that is displayed) is broken until the second image 566″ is fully displayed. As seen in the intermediate image 576 of FIG. 13E, for example, the segments of the second image 566″ may be segments that are not adjacent or contiguous until the second image 566″ is fully displayed.

In the example transition of FIG. 13F, the first image 566′ remains unchanged (other than being progressively covered by the second image 566″), while the second image 566″ rotates into a position that covers the first image 566′. For example, the second image 566″ and first image 566′ may share a common point (e.g., in the example transition of FIG. 13F, the upper left corner) about which the second image 566″ pivots or rotates to cover the first image 566′. Alternatively, the second image 566″ and first image 566′ may share a common axis (e.g., the top, bottom, left, or right of the first image 566′) about which the second image 566″ appears to pivot or rotate to cover the first image 566′, such that the second image 566″ appears to rotate in three dimensions.

While each of the example transitions in FIGS. 13A-13F only displays images (or portions of images) within the bounds of the display area originally occupied by the first image 566′, other implementations may include transitioning effects with animation displays that extend outside of the initial display area of the first image 566′. As one example, and with reference to FIG. 13D, the second image 566″ may fade in or intensify to the left of the first image 566′, after which the entire, fully displayed second image is shifted to cover the first image 566″.

Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, at least some of the operations may be performed by a group of computers (as examples of machines including processors), these operations being accessible via a network (e.g., the Internet) and via one or more appropriate interfaces (e.g., application program interfaces (APIs).)

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for a system and a process for rendering information on a mobile computing device having a display screen through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method in a computing device for unobtrusively updating images being displayed in connection with a digital map, the method comprising:
displaying a digital map of a first geographic area and a first plurality of images related to the first geographic area;
receiving a selection of a second geographic area; and
in response to the selection of the second geographic area, displaying a digital map of the second geographic area and a second plurality of images related to the second geographic area, including temporarily, for a perceivable amount of time, displaying one of the first plurality of images with the digital map of the second geographic area, wherein the displayed one the first plurality of images is unrelated to the second geographic area.

2. The method of claim 1, wherein temporarily displaying the one of the first plurality of images with the digital map of the second geographic area includes simultaneously displaying at least some of the second plurality of images.

3. The method of claim 1, wherein temporarily displaying one of the first plurality of images includes at least one of:
gradually fading the image,
gradually decreasing a size of the image, or
progressively covering the image with one of the second plurality of images.

4. The method of claim 1, wherein the displayed one of the first plurality of images depicts an object located in the first geographic area but not in the second geographic area.

5. A computer-readable memory having stored thereon a plurality of instructions for transitioning between images supplementing a map display, the plurality of instructions including instructions that, when executed by one or more processors, cause the one or more processors to:
display a digital map of a first geographic area viewed from a first observation point;
receive first image data representing a first set of one or more images of one or more objects within the first geographic area, wherein the first set of images includes a first image of a first object viewed from a second observation point different than the first observation point;
display the first set of one or more images;
receive a request for map information corresponding to a revised geographic area;
display a revised digital map of the revised geographic area viewed from a third observation point, wherein the revised geographic area does not include the first object;
receive second image data image data representing a second set of one or more images of one or more objects within the revised geographic area, wherein the second set of images includes a second image of a second object viewed from a fourth observation point different than the third observation point, and wherein the second image is different than the first image;
after the revised digital map is displayed, transition from the display of the first set of images to a display of the second set of images by concurrently displaying at least a portion of the first image and at least a portion of the second image for a perceivable amount of time; and
upon completion of the transition from the display of the first set of images to the display of the second set of images, display the second set of images but not the first image.

6. The computer-readable memory of claim 5, wherein the instructions cause the one or more processors to:
display the first set of images in a first display area; and
display the second set of images in a second display area at least partially overlapping the first display area.

7. The computer-readable memory of claim 5, wherein the instructions cause the one or more processors to transition from the display of the first set of images to the display of the second set of images by at least one of:
fading the first image;
intensifying the second image;
decreasing a size of the first image;
increasing a size of the second image;
progressively covering the first image; and
progressively revealing the second image.

8. The computer-readable memory of claim 7, wherein the instructions cause the one or more processors to transition from the display of the first set of images to the display of the second set of images further by at least one of:
shifting the first image;
shifting the second image;
rotating the first image; and
rotating the second image.

9. The computer-readable memory of claim 7, wherein the instructions cause the one or more processors to transition from the display of the first set of images to the display of the second set of images by progressively covering the first image with the second image.

10. The computer-readable memory of claim 9, wherein the instructions cause the one or more processors to transition from the display of the first set of images to the display of the second set of images by progressively sliding the second image over the first image.

11. The computer-readable memory of claim 9, wherein the instructions cause the one or more processors to transition from the display of the first set of images to the display of the second set of images by progressively covering multiple segments of the first image with multiple disjointed segments of the second image.

12. The computer-readable memory of claim 5, wherein the third observation point is the same as the first observation point.

13. The computer-readable memory of claim 5, wherein the request for map information is indicative of at least one of:
a magnification command entered by a user;
a panning command entered by a user; and
an address entered by a user.

14. The computer-readable memory of claim 5, wherein the instructions cause the one or more processors to transition from the display of the first set of images to the display of the second set of images starting at least a predetermined time interval after the revised map is displayed.

15. The computer-readable memory of claim 5, wherein the instructions cause the one or more processors to transition from the display of the first set of images to the display of the second set of images starting at least a predetermined time interval after receiving the request for map information.

16. The computer-readable memory of claim 5, wherein the perceivable amount of time is at least 0.5 seconds.

17. The computer-readable memory of claim 5, wherein the instructions cause the one or more processors to:
display the first set of images in a display area overlaying a display area of the digital map; and
display the second set of images in a display area overlaying a display area of the revised digital map.

18. A computer-implemented method for transitioning between images supplementing a map display, the method comprising:
displaying via a user interface a digital map of a first geographic area viewed from a first observation point;
receiving first image data representing a first set of one or more images of one or more objects within the first geographic area, wherein the first set of images includes a first image of a first object viewed from a second observation point different than the first observation point;
displaying via the user interface the first set of one or more images;
receiving via the user interface a request for map information corresponding to a revised geographic area;
displaying via the user interface a revised digital map of the revised geographic area viewed from a third observation point, wherein the revised geographic area does not include the first object;
receiving second image data representing a second set of one or more images of one or more objects within the revised geographic area, wherein the second set of images includes a second image of a second object viewed from a fourth observation point different than the third observation point, and wherein the second image is different than the first image;
after the revised digital map is displayed, transitioning from displaying via the user interface the first set of images to displaying via the user interface the second set of images by concurrently displaying via the user interface at least a portion of the first image and at least a portion of the second image for a perceivable amount of time; and
upon completion of transitioning from displaying via the user interface the first set of images to displaying via the user interface the second set of images, displaying via the user interface the second set of images but not the first image.

19. The computer-implemented method of claim 18, wherein:
displaying via the user interface the first set of images includes displaying via the user interface the first image in a first display area; and
displaying via the user interface the second set of images but not the first image includes displaying the second image in a second display area that at least partially overlaps the first display area.

20. The computer-implemented method of claim 18, wherein transitioning from displaying via the user interface the first set of images to displaying via the user interface the second set of images includes at least one of:
fading the first image;
intensifying the second image;
decreasing a size of the first image;
increasing a size of the second image;
progressively covering the first image; and
progressively revealing the second image.

21. The computer-implemented method of claim 20, wherein transitioning from displaying via the user interface the first set of images to displaying via the user interface the second set of images includes progressively covering the first image with the second image.

22. The computer-implemented method of claim 18, wherein transitioning from displaying via the user interface the first set of images to displaying via the user interface the second set of images includes starting to transition from displaying via the user interface the first set of images to displaying via the user interface the second set of images at least a predetermined time interval after the revised digital map is displayed.

23. A method for transitioning between overlay images displayed with a digital map, the method comprising:
displaying on a screen a digital map of a first geographic area viewed from a first observation point;
identifying a first image of a first object located within the first geographic area and viewed from an observation point different than the first observation point;
displaying the identified first image on the screen;
receiving a request for map information from a user;
generating a revised digital map of a revised geographic area viewed from a second observation point and corresponding to the request for map information, wherein the revised geographic area does not include the first object;
displaying the revised digital map on the screen;
identifying a second image of a second object located within the revised geographic area and viewed from an observation point different than the second observation point;
after the revised digital map is displayed, transitioning the display of the first image to a display of the second image on the screen by using a transitioning effect to concurrently display at least a portion of the first image and at least a portion of the second image on the screen for a perceivable amount of time; and
displaying the second image, but not the first image, on the screen upon completion of the transitioning from the first image to the second image.

24. The method of claim 23, wherein the transitioning effect includes at least one of:
fading the first image;
intensifying the second image;
decreasing a size of the first image;
increasing a size of the second image;
progressively covering the first image; and
progressively revealing the second image.
